(19) United States
(12) Patent Application Publication
(10) Pub. No.: US 2006/0224704 A1
(43) Pub. Date: Oct. 5, 2006

(54) Auto-configuration for data collection terminals

(76) Inventors: Vijay Parikh, Totowa, NJ (US); Dariusz Ruszala, Fairfield, NJ (US); Robert Brady, Emerson, NJ (US); Jim Kovacs, Parsippany, NJ (US)

Correspondence Address: STETINA BRUNDA GARRED & BRUCKER, 75 ENTERPRISE, SUITE 250, ALISO VIEJO, CA, 92656, US

(21) Appl. No.: 11/096,780

(22) Filed: Apr. 1, 2005

(51) Int. Cl. G06F 15/177

(52) U.S. Cl. 709/220

(57) ABSTRACT

A system, method and computer readable medium is provided for automatically configuring at least one un-configured data collection terminal (DCT) interfaced to a network utilizing TCP/IP protocol. The network may include a plurality of devices, including at least one client or server. The system and method includes determining the presence of a DHCP server; obtaining an IP address utilizing DHCP protocol if a DHCP is confirmed in communication with the network; allocating an IP address in a link-local addressing range if it is confirmed a DHCP is not in communication with the network; broadcasting data indicative of a presence on the network to the at least one client or server; initiating a browsing sequence in which the at least one DCT or the at least one client or server, sends a query to all connected devices on the subnet requesting a list of all devices that match a service type/protocol name and domain that the at least one DCT is adapted to communicate therewith; and the at least one DCT, or the at least one client or server, receiving responses from devices on the subnet in which the response includes each device's qualified name.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Field of the Invention

The present invention relates to data collection terminals (DCTs) interfaced to a network which utilizes TCP/IP protocol. And in particular, the present invention relates to the configuration and administration of data collection terminals in the absence of an in-place network and network administration facilities.

2. Background of the Invention

Traditionally, data collection terminals that are designed to be connected to a Transmission Control Protocol/Internet Protocol (TCP/IP) network are delivered to customers without being configured to be installed on the TCP/IP network. The data collection terminals require advanced configuration and often require intervention from highly skilled network administration staff. In addition, each application that communicates with the data collection terminals typically must also be configured.

The general process for configuring a data collection terminal involves numerous steps. First, an available IP address or range of IP addresses and TCP/IP port numbers on the network that will be reserved for the data collections terminals that are to be used must be negotiated and reserved. Next, each of the terminals must be assigned an IP address. In the presence of a Dynamic Host Configuration Protocol (DHCP) server, a DHCP address must be supplied to the terminal. Additionally, every client device installed on the network that wishes to communicate with the data collection terminal must be configured with the correct IP address. Furthermore, for real-time terminals, a server IP address must be entered.

The aforementioned accepted industry norm has numerous disadvantages. For instance, a block of static IP address must be reserved for use so that they can be individually assigned to each data collection terminal intended to be installed on the network. This involves the assistance of trained network support staff at a cost of time and money. When a data collection terminal is first purchased, the network configuration must be “programmed” into each data collection terminal. This involves a complex series of operations that must be repeated for each and every data collection terminal that is intended to be used. If a mistake is made here, such as the same address is assigned to more then one data collection terminal, communication capability is hindered and a support call typically has to be placed to network support staff. Also, each and every client application that wishes to communicate with the data collection terminals must have the correct IP address entered into the configuration section of the application. This routinely causes support calls if the customer does not have the correct IP address or if the IP address of the data collection terminal has changed (address is reassigned manually or a new address is provided by the DHCP server). Moreover, when the data collection terminal is used in a real-time environment, a server address must be supplied to each and every data collection terminal. This becomes a management issue when a DCHP server is not available. In an “ad-hoc” environment such as this, there is often no qualified support staff to assist in configuration. And finally, many standard data collection terminals do not provide presence information. Thus, there is no way for clients to see if a terminal is actively communicating without sending a TCP/IP Ping command to the IP address. Moreover, this method only checks to see if there is a device connected at the specified IP address, it does not prove that a data collection terminal exists at the specified IP address.

It would be beneficial to develop a method and/or computer readable medium which is adapted to simplify the process for configuring data collection terminals. Ideally, a method and/or computer readable medium which would allow for simple plug and play set-up of data collection terminals would be the most beneficial because it would decrease the amount of overhead required for each installation. Preferably, the method and/or computer readable medium would be user-friendly such that one with minimal computer skills could install data collection terminals quickly without the need for a highly skilled network support staff.

### BRIEF SUMMARY OF THE INVENTION

The present invention is intended to overcome and solve the aforementioned problems commonly encountered in configuring data collection terminals interfaced to TCP/IP networks.

The present invention is a system, method and/or computer readable medium which automatically configures data collection terminals, and as a result, eliminates the aforementioned disadvantages found in the manner in which data collection terminals are currently typically configured. One significant aspect of the present invention, is that it frees up clients and data collection terminals on a network from having to deal with IP addressing which is a somewhat tedious process.

In general, the present invention (also referred to “the auto-configuration system” for data collection terminals) preferably includes three phases or sequences, including: (1) addressing, (2) broadcasting, and (3) browsing.

The addressing phase includes each data collection terminal automatically assigning itself an address selected from a designated address group. Preferably, the address is selected from the 169.254/16 TCP/IP addressing range. Next, a broadcasting phase is initiated, which includes each data collection terminal broadcasting its presence on the network to all interested clients. This phase is initiated since the data collection terminal does not know in advance which clients are configured to communicate are adapted to or interested in communicating with the data collection terminal. Then, the interested clients browse for available data collection terminals. Clients ask an auto-configuration sub-system for all devices that support data collection services.

Furthermore, an optional server detection start-up phase or sequence may also be implemented after the first three phases are complete. In particular, the auto-configuration system or method provides the data collection terminals with the capability of automatically finding a server to communicate upon start-up. This allows for a simple plug and play setup of the data collection terminals.

It is important to note that through out this entire negotiation process, an IP address is not required by any endpoint for establishing a connection. As already stated, the present invention may be embodied as a system, method and/or computer readable medium, such as software or embedded logic.

Accordingly, a first exemplary embodiment of the present invention provides a method for automatically configuring at least one un-configured data collection terminal interfaced to a network utilizing TCP/IP protocol. The network may include a plurality of devices in communication with the network, such as clients and servers.

The aforementioned method preferably includes determining the presence of a Dynamic Host Configuration Protocol (DHCP) server; obtaining an IP address utilizing DHCP protocol if a DHCP is confirmed in communication with the network; allocating an IP address in a Link-Local addressing range if it is confirmed that a DHCP is not in communication with the network; broadcasting data indicative of a presence on the network to at least one client or server; initiating a browsing sequence in which the at least one data collection terminal, or the at least one client or server, sends a query to all connected devices on the subnet of presence requesting a list of all devices that match a service type/protocol name and domain that the at least one data collection terminal is adapted to communicate therewith; and the at least one data collection terminal, or the at least one client or server, receiving responses from devices on the subnet of presence in which the response includes each device's qualified name.

According to another aspect of the present invention, allocating an IP address in the Link-Local addressing range includes randomly selecting an IP address from a designated address group; sending at least one Address Request Protocol (ARP) request to the selected random IP address to determine whether the selected random IP address has been selected; and confirming that the randomly selected IP address is not in use.

According to other aspects of the present invention, the designated address group is preferably from the 169.254/16 address group. In another aspect of the present invention, receiving an error message is indicative that the selected random IP address is in use.

A further aspect of the present invention, broadcast data includes at least a name of the at least one data collection terminal, the selected random IP address, and a port number in which communication there through. Additionally, the broadcast may be performed via multicast to all devices on the subnet of presence. Moreover, the broadcasting may be initiated upon start-up at a high interval of about once every millisecond until about one minute has elapsed, and wherein the broadcasting is exponentially backed off to about one broadcast every minute.

According to another aspect of the present invention, the name of the at least one data collection terminal includes a user definable name, service type/protocol name and domain. The definable name may be a standard UTF-8 text string. Preferably, the service type/protocol name is designated “_datacollection._tcp” for a data collection terminal and the service type/protocol name is designated “_datasevr.tcp_tcp.” for servers that wish to be located by the at least one data collection terminals.

In another aspect of the present invention, the query is sent to all connected devices on the subnet via multicast. In another aspect of the present invention, the at least one data collection terminal immediately initiates communication with the at least one client or server which has responded.

Additionally, a second embodiment of the present invention provides a computer readable medium storing a computer program is provided for automatically configuring at least one un-configured data collection terminal interfaced to a network utilizing the TCP/IP protocol. The network may include a plurality of devices in communication with the network, the plurality of devices including at least one of a client or server.

The aforementioned medium preferably comprises a source code segment for determining the presence of a Dynamic Host Configuration Protocol (DHCP) server; a source code segment for obtaining an IP address utilizing DHCP protocol if a DHCP is confirmed in communication with the network; a source code segment for allocating an IP address in a Link-Local addressing range if it is confirmed a DHCP is not in communication with the network; a source code segment for broadcasting data indicative of a presence on the network to the at least one client or server; a source code segment for initiating a browsing sequence in which the at least one data collection terminal, or the at least one client or server, sends a query to all connected devices on the subnet of presence requesting a list of all devices that match a service type/protocol name and domain that the at least one data collection terminal is adapted to communicate therewith; and a source code segment for the at least one data collection terminal, or the at least one client or server, to receive responses from devices on the subnet of presence in which the response includes each device's qualified name.

In another aspect of the present invention, the computer readable medium further includes a source code segment for the at least one data collection terminal to immediately initiate communication with the at least one client or server which has responded.

Other exemplary embodiments and advantages of the present invention may be ascertained by reviewing the present disclosure and the accompanying drawings.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 illustrates an exemplary TCP/IP network, according to an aspect of the present invention;

FIG. 2 is an overview flow diagram of an exemplary auto-configuration method, according to an aspect of the present invention; and

FIG. 3 is a flow diagram of the auto-configuration sequence, according to an aspect of the present invention.

### DETAILED DESCRIPTION OF THE INVENTION

The present invention is intended to overcome and solve the aforementioned problems commonly encountered in configuring data collection terminals interfaced to TCP/IP networks.

The present invention is a system, method and/or computer readable medium which automatically configures data collection terminals, and as a result, eliminates the aforementioned disadvantages found in the manner in which data collection terminals are currently configured. As already discussed in the Background of the Specification, the manner in which data collection terminals are typically configured requires substantial time and labor which increase the overall cost to manage and operate the network. The present invention frees up clients and data collection terminals on the network from having to deal with IP addressing.

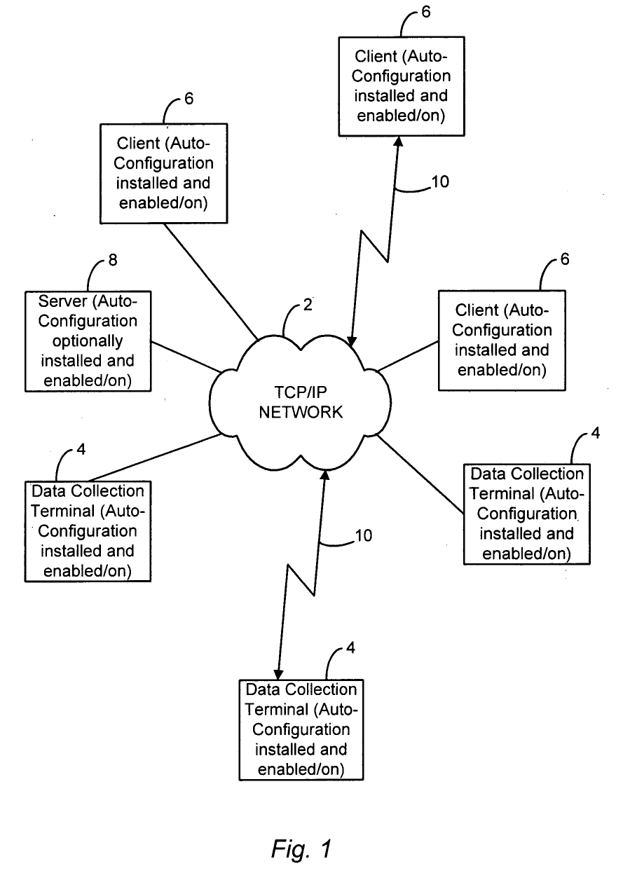

FIG. 1 is illustrates an exemplary TCP/IP network 2, according to an aspect of the present invention. The exemplary TCP/IP network 2 may be embodied as a Local Area Network (LAN) which includes a plurality clients 6 and servers 8. The TCP/IP network 2 may further be embodied as a Wide Area Network (WAN) such as an internet, the Internet and/or an intranet. Thus, the WAN may include hubs, switches/bridges, routers and gateways (not shown). Also, the network 2 may be embodied as a metropolitan area network (MAN), which as the name suggests, occupies a middle ground between LANs and WANs. Moreover, the exemplary TCP/IP network 2 may include wireless systems, as indicated by wireless links 7.

As shown in FIG. 1, the exemplary TCP/IP network 2 includes at least one data collection terminal 4. For purposes of the present invention, a data collection terminal 4 may be defined to include any device which is capable of accepting/receiving data and/or information which can be interfaced to a network via hardline or wireless.

For example, a data collection terminal 4 may include, but is not limited to, parking security systems, pay stations, card readers, ticket dispensers, entrance and exit gates, proximity readers, fee computers, license plate identification systems, time clocks, time cards, punch clocks, recorders, recorders, date/time stamp equipment, biometric readers and other personnel tracking systems. Moreover, a data collection terminal 4 may be a dumb terminal, smart terminal, intelligent terminal, NC terminal, computer, personal computer, work station. Also a data collection terminal 4 may be considered a wireless device, PDA, cell phone or VOIP telephone system.

Additionally, as shown in FIG. 1, the exemplary TCP/IP network 2 may include clients and servers. A client 6 may be, for instance, a personal computer or any other device on the network 2 that permits its user to request the shared services provided by the network server 8. And the server 8 may be, for instance, a PC, workstation or any other device that shares its resources as a service to the network users, including the clients 6.

Furthermore, as shown in FIG. 1, auto-configuration source code or embedded logic should be provided in each data collection terminal 4 and each client 6 so that the aforementioned devices may implement the exemplary auto-configuration method herein disclosed as an aspect of the present invention. Therefore, the required software may be embedded or loaded into any device that wishes to provide auto-configuration capability and client software that wishes to use auto-configuration capability.

Another aspect of the present invention is that identical source code or embedded logic can be installed on each device intended to use the auto-configuration system or methods, therefore eliminating the need for specialized source code for different devices. As a result, the present invention may be universally installed on data collection devices 4, clients 6, servers 8, and even hubs, switches/bridges, routers and gateways (not shown). However, it is also noted that the auto-configuration source code or embedded logic is not required to be installed on the server 8 or hubs, switches/bridges, routers and gateways (not shown) if such devices are part of the TCP/IP network 2.

The source code may be in the form of any computer readable medium, such as conventional software or be in the form of embedded logic, including, but not limited to, application specific integrated circuits, programmable logic arrays and other hardware devices. Additionally, the source code may be written in any suitable computer programming language.

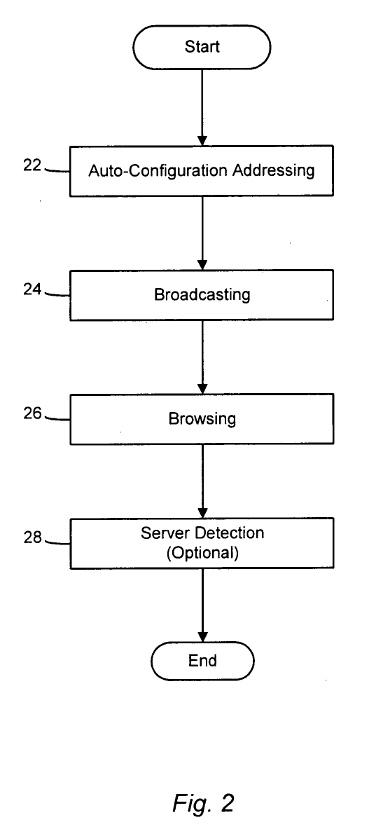

FIG. 2 is an overview flow diagram of an exemplary auto-configuration method, according to an aspect of the present invention. As stated earlier, auto-configuration can be broken down into three main phases or sequences, including an: auto-configuration addressing phase 22, a broadcasting phase 24, a browsing phase 26. Furthermore, an optional server detection start-up phase or sequence 28 may also be implemented after the first three phases are complete. Each of these phases or sequences is now herein described below in greater detail.

Auto-Configuration Addressing Phase

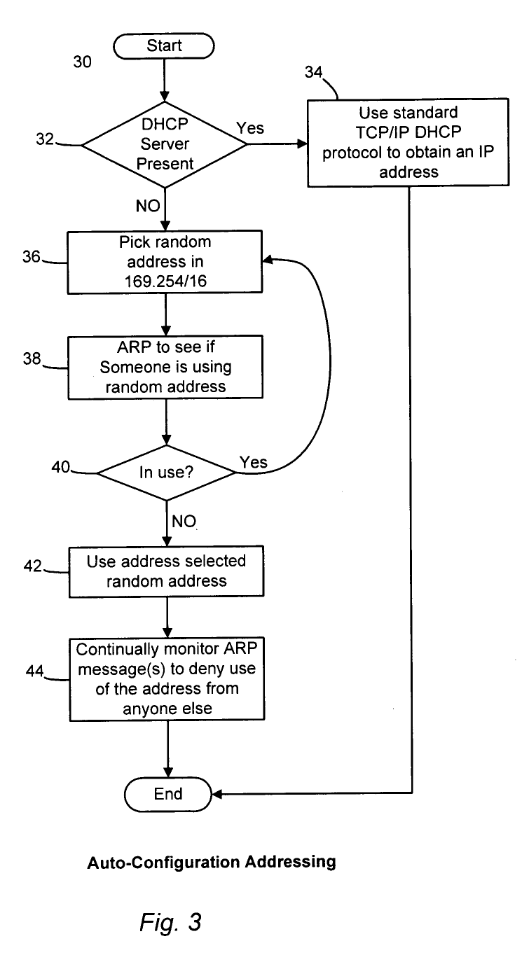

FIG. 3 is a flow diagram of an exemplary auto-configuration phase or sequence 22, according to an aspect of the present invention. The first objective of the auto-configuration system, method or computer readable medium is for the data collection terminal 4 to obtain an IP address. At step 30, the auto-configuration addressing phase is initiated. At step 32, the presence of a DHCP server in the network 2 is determined. If a DHCP server is determined to be present, then at step 34, the data collection terminal 4 will utilize the standard TCP/IP DHCP protocol to obtain an IP address. This branch of the sequence then ends at step 44.

In the absence of a DCHP server at step 32, the data collection terminal 4 attempts to allocate an IP address in the link-local addressing range of the TCP/IP protocol. An exemplary method of address allocation in the link-local space is next herein discussed. At step 36, a random address in the link-local layer is selected. This is preferably the block of IP addresses in the 169.254/16 address group. However, it is recognized that that the IP addresses set aside for the link-local addressing range may change in time, and that the present invention should not be limited to only the 169.254/16 address group. Rather, the present invention may utilize other Link-Local addressing ranges which may be set aside to perform similar functions.

After a random address is selected from a designated address group such as the exemplary 169.254/16 address group (or equivalent) at step 36, an Address Request Protocol (ARP) request is sent to the selected random address to see if any device is using the random address on the network 2 at step 38. In general, the ARP request contains the IP address of a destination host and performs the request “if you are the owner of this IP address, please respond to me with your hardware address”. The destination's host's ARP layer receives the broadcast, recognizes that the sender is asking for its hardware address, and replies with an ARP reply. The reply contains the IP address and the corresponding hardware address.

At step 40, if the ARP request indicates that the randomly selected address is in use, then the process returns to step 36 where another random address is selected in the designated address group such as the 169.254/16 address group (or equivalent). For instance, one exemplary approach using the ARP request to determine whether the randomly selected address is in use entails verifying whether an error message is received after the ARP request has been sent at step 38. If an error message is received after the ARP request is sent at step 38, this typically is indicative that the address is already in use.

After it is determined whether the randomly selected address is not being utilized on the network 2 at step 40, the randomly selected address is then confirmed as the IP address which will be utilized by the data collection terminal 4 at step 42. Once the address has been identified and confirmed at step 42, the ARP message(s) are monitored at step 44 to deny anyone else the use of the randomly selected address on the network 2. Finally, at step 42, the auto-configuration addressing phase or sequence ends at step 44.

Broadcasting Phase

This second phase of auto configuration includes broadcasting 22 the data collection terminal's 4 presence on the network 2 to all interested clients 6, servers 8 or any other device having the auto-configuration system capabilities installed. For example, this phase of the auto-configuration system uses the multicast system of TCP/IP protocol to send messages to all clients 4 on the current subnet of presence. In one exemplary broadcast configuration, the data collection terminal 4 is configured to broadcast on start-up at a high interval of once every millisecond until one minute has elapsed. Then the auto-configuration system will exponentially back off broadcasting until it adjusts to a level of one broadcast every minute.

The broadcast data preferably includes the name of the data collection terminal 4 with the IP address and the port number that it wishes to conduct communications within. An exemplary broadcast name may include a user definable name, service type/protocol name, and the domain name. The user definable name, which is the name that the data collection terminal will be known as, may comprise a standard UTF-8 text string. The service type/protocol name, which represents the protocol that will be used for communications, preferably will be “_datacollection._tcp.” for data collection terminals 4 and “_datasever._tcp.” for servers 6 that wish to have data collection terminals 4 automatically find them. And in another exemplary embodiment, the domain will always be local.

In case where a device or clients attempts to register a service name with one that already exists, that client must choose another name. The recommended method is the append a number to the name that us to attempt broadcasting.

Browsing Phase

The final stage of auto-configuration is browsing 26. In order to browse, any device on the network which has the auto-configuration system installed, will be able to request a list of all devices on the network 2 that match a service type/protocol name and the domain that they wish to be on. For example in one embodiment, a fixed query of “_datacollection._tcp.local.” will preferably be utilized for data collection terminals 4. While, a fixed query of “_dataserver._tcp.local” will be utilized for servers 8, and fixed quert of “_dataclient_tcp.local” will be utilized for clients. Furthermore, in the aforementioned embodiment, the domain is preferred to be local.

The query preferably will be sent to all connected devices on the subnet via multicast. All devices that are part of the auto-configuration system will then respond with their fully qualified name. An exemplary fully qualified name may be “FrontDoor._datacollection._tcp.local.” for data collection terminals, “ServerHQ._dataserver._tcp.local.” for a server 8 and “ClientAB_dataserver_tcp.local” for a client 6.

After the browsing phase 26 has been executed, the data collection terminal 4 will have been automatically configured without the need for any manual configuration steps from an installation technician or the network administration staff. Therefore, the task of negotiating an available IP address; assigning the data collection terminals IP addresses, configuring clients with the correct corresponding address, and the real-time entering of server IP addresses will have been entirely eliminated.

Server Detection on Start-Up

Another aspect of the auto-configuration system is that it optionally gives data collection terminals 4 a unique capability of automatically finding a server 8 to communicate to upon start-up. This allows for a simple plug and play setup of data collection terminals 4. The server detection on start-up sequence 28 utilizes the auto-configuration addressing phase 22, broadcasting phase 24, and browsing phase 26 which has already been discussed. Then the data collection terminal 4 is configured to automatically initiate communications with a server 8.

An exemplary start-up sequence which implements server detection on start-up 8 is now herein discussed below. On power-up, the data collection terminal 4 obtains an IP address as described above in the Auto-Configuration Addressing section of the specification. Next, the data collection terminal 4 registers with an auto-configuration subnet using multicast as described earlier in the Broadcasting section of the specification. Next, the data collection terminal then browses for available servers 8 to communicate to by issuing a query for “_dataserver._tcp.local.”. Finally, the data collection terminal 4 then automatically initiates communications with one of the servers 8 that are returned.

Other Aspects of the Present Invention

Although the present specification describes components and functions implemented in the embodiments with reference to particular standards and protocols, the present invention is not limited to such standards and protocols. Each of the standards for the Internet and other packet-switched network transmission (e.g., TCP/IP, UDP/IP, HTML, SHTML, DHTML, XML. PPP, FTP, SMTP, MIME) represent examples of the various state of the art packet-switching protocols. Such standards are periodically superseded by faster or more efficient equivalents having essentially the same functions. Accordingly, replacement standards and protocols having the same functions are considered equivalents. For instance, the present invention may be suited for IPv4 or the next superseding protocol, such as IPv6.

In accordance with various embodiments of the present invention, the system and method described herein may be implemented as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual processing can also be constructed to implement the methods described herein.

It should also be noted that the software implementations of the present invention as described herein are optionally stored on a tangible storage medium, such as: a magnetic medium such as disk or tape; a magneto-optical or optical medium such as a disk; or a solid state medium such as a memory card or other package that houses one or more read-only (non-volatile) memories, random access memories, or other re-writable (volatile) memories. Accordingly, the invention is considered to include a tangible storage medium or distribution medium, as listed herein and includes art recognized equivalents and successor media, in which the software implementations herein are stored.

Moreover, the particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A method for automatically configuring at least one un-configured data collection terminal interfaced to a network utilizing TCP/IP protocol, the network including a plurality of devices in communication therewith, the plurality of devices including at least one of a client or server, the network including a defined subnet, the method comprising:
determining the presence of a Dynamic Host Configuration Protocol (DHCP) server;
obtaining an IP address utilizing DHCP protocol if a DHCP is confirmed in communication with the network;
allocating an IP address in a link-local addressing range if it is confirmed a DHCP is not in communication with the network;
broadcasting data indicative of a presence on the network to the at least one client or server;
initiating a browsing sequence in which the at least one data collection terminal, or the at least one client or server, sends a query to all connected devices on the subnet requesting a list of all devices that match a service type/protocol name and domain that the at least one data collection terminal is configured to communicate therewith; and
the at least one data collection terminal, or the at least one client or server, receiving responses from devices on the subnet in which the response includes each device's qualified name.

2. The method according to claim 1, wherein allocating an IP address in the link-local addressing range comprises,
randomly selecting an IP address from a designated address group;
sending at least one Address Request Protocol (ARP) request to the selected random IP address to determine whether the selected random IP address has been selected; and
confirming that the randomly selected IP address is not in use.

3. The method according to claim 2, wherein the designated address group is the 169.254/16 address group.

4. The method according to claim 2, wherein receiving an error message is indicative that the selected random IP address is in use.

5. The method according to claim 4, wherein the broadcast data includes at least a name of the at least one data collection terminal, the selected random IP address, and a port number in which communication there through is desired.

6. The method according to claim 1, wherein the broadcast is performed via multicast to all devices on the subnet.

7. The method according to claim 1, wherein broadcasting is initiated upon start-up at a high interval of about once every millisecond until about one minute has elapsed.

8. The method according to claim 7, further including exponentially backing off broadcasting to about one broadcast every minute.

9. The method according to claim 1, wherein the name of the at least one data collection terminal includes a user definable name, service type/protocol name, and domain.

10. The method according to claim 9, wherein the definable name is a standard UTF-8 text string.

11. The method according to claim 9, wherein the service type/protocol name is designated “_datacollection._tcp” for a data collection terminal.

12. The method according to claim 9, wherein the service type/protocol name is designated “_dataserver.tcp_tcp.” for servers that wish to be located by the at least one data collection terminal.

13. The method according to claim 1, wherein the query is sent to all connected devices on the subnet via multicast.

14. The method according to claim 1, further including the at least one data collection terminal immediately initiating communication with the at least one client or server which has responded.

15. A computer readable medium storing a computer program for automatically configuring at least one un-configured data collection terminal interfaced to a network utilizing TCP/IP protocol, the network including a plurality of devices in communication therewith, the plurality of devices including at least one of a client or server, the network including a defined subnet, the medium comprising:
a source code segment for determining the presence of a Dynamic Host Configuration Protocol (DHCP) server;
a source code segment for obtaining an IP address utilizing DHCP protocol if a DHCP is confirmed in communication with the network;
a source code segment for allocating an IP address in a link-local addressing range if it is confirmed a DHCP is not in communication with the network;
a source code segment for broadcasting data indicative of a presence on the network to the at least one client or server;
a source code segment for initiating a browsing sequence in which the at least one data collection terminal, or the at least one client or server, sends a query to all connected devices on the subnet requesting a list of all devices that match a service type/protocol name and domain that the at least one data collection terminal is adapted to communicate therewith; and
a source code segment for the at least one data collection terminal, or the at least one client or server, to receive responses from devices on the subnet in which the response includes each device's qualified name.

16. The medium according to claim 15, wherein allocating an IP address in the link-local addressing range comprises,
randomly selecting an IP address from a designated address group;
sending at least one Address Request Protocol (ARP) request to the selected random IP address to determine whether the selected random IP address has been selected; and
confirming that the randomly selected IP address is not in use.

17. The medium according to claim 16, wherein the designated address group is the 169.254/16 address group.

18. The medium according to claim 16, wherein receiving an error message is indicative that the selected random IP addresses is in use.

19. The medium according to claim 18, wherein the broadcast data includes at least a name the at least one data collection terminal, the selected random IP address, and a port number in which communication there through is desired.

20. The medium according to claim 15, wherein the broadcast is performed via multicast to all devices on the subnet.

21. The medium according to claim 15, wherein the broadcasting is initiated upon start-up at a high interval of about once every millisecond until about one minute has elapsed.

22. The medium according to claim 21, further including exponentially backing off broadcasting to about one broadcast every minute.

23. The medium according to claim 15, wherein the name of the at least one data collection terminal includes a user definable name, service type/protocol name, and domain.

24. The method according to claim 23, wherein the definable name is a standard UTF-8 text string.

25. The method according to claim 23, wherein the service type/protocol name is designated “_datacollection._tcp” for a data collection terminal.

26. The medium according to claim 23, wherein the service type/protocol name is designated “_dataserver.tcp_tcp.” for servers that wish to be located by the at least one data collection terminal.

27. The medium according to claim 15, wherein the query is sent to all connected devices on the subnet via multicast.

28. The medium according to claim 15, further including at least one source code segment for the at least one data collection terminal to immediately initiate communication with the at least one client or server which has responded.
